(19) United States
(12) Patent Application Publication
(10) Pub. No.: US 2005/0195150 A1
(43) Pub. Date: Sep. 8, 2005

(54) Display panel and display device

(75) Inventors: Sunao Etoh, Matsuzaka-shi (JP); Kazuyoshi Imae, Tenri-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/068,391

(22) Filed: Mar. 1, 2005

(30) Foreign Application Priority Data
Mar. 3, 2004 (JP) 2004-058460
Mar. 4, 2004 (JP) 2004-060472
Mar. 9, 2004 (JP) 2004-065673

(51) Int. Cl. G09G 3/36

(52) U.S. Cl. 345/100

(57) ABSTRACT

In a display device, at least one of a first drive circuit that feeds source signals to first pixels to be viewed from a first viewing direction and a second drive circuit that feeds source signals to second pixels to be viewed from a second viewing direction includes a shift register that generates a sampling pulse by shifting a start pulse in synchronism with a clock signal, a sampling circuit that samples an image signal according to the sampling pulse, and a switch that controls according to a switch signal whether or not to feed the clock signal to the shift register or whether or not to feed the start pulse to the shift register. The first and second pixels are driven by the use of the output signal of the sampling circuit. With this configuration, a plurality of viewers can be presented with different images simultaneously with minimum waste of electric power.

### CROSS-REFERENCE TO RELATED APPLICATIONS

(1) Japanese patent application laid-open No. 2004-058460 filed on Mar. 3, 2004

(2) Japanese patent application laid-open No. 2004-060472 filed on Mar. 4, 2004

(3) Japanese patent application laid-open No. 2004-065673 filed on Mar. 9, 2004

### BACKGROUND OF THE INVENTION

1. Field of the Invention

The present invention relates to a display panel and to a display device. More particularly, the present invention relates to a dual-view display device that permits different images to be viewed from different directions.

2. Description of Related Art

According to one conventionally proposed technology for sharing a single display device among a plurality of viewers, image signals from which to reproduce images are switched according to the angle at which the display device is rotated (see Japanese Patent Application Laid-Open No. H2-144242). According to another conventionally proposed technology, a car-mounted display is suspended from the ceiling of a car so as to be located at about the center of the windshield so that high viewability is obtained at any passenger seat (see Japanese Utility Model Registered No. 3045443). Many similar and various disclosures and proposals have been made to date.

However, the display devices disclosed in the publications mentioned above are not designed to present information simultaneously to a plurality of viewers who want to view different kinds of information.

To accommodate such needs, there has conventionally been disclosed and proposed a dual-view display device for use as a car-mounted display device or the like integrated into a car navigation system or the like. In such a situation, a viewer on the driver's seat and a viewer on the assistant driver's seat view a single display device from different directions. Accordingly, such a dual-view display device comprises: a display panel having first pixels that output image light to be directed in a first viewing direction (to present, for example, images of maps that the viewer on the driver's seat wants to view) and second pixels that output image light to be directed in a second viewing direction (to present, for example, images of television programs that the viewer on the assistant driver's seat wants to view); and an optical separator that is arranged on the front face of the display panel to separate the image lights outputted from the first and second pixels so as to direct them in the first and second viewing directions, respectively (see, for example, Japanese Patent Application Laid-Open No. 2003-76289).

FIG. 12 is an outline structure diagram (outline sectional view) of a conventional dual-view display device. The display device D shown in FIG. 12 permits different images to be viewed simultaneously from a leftward and a rightward direction with respect to the front face of the display panel.

A display panel D4 includes “a1” pixels D41, “a2” pixels D42, and “a3” pixels D43 for displaying a first image. The display panel D4 further includes “b1” pixels D44, “b2” pixels D45, and “b3” pixels D46 for displaying a second image. These pixels are individually driven by a driver D1 so that the first and second images are displayed on the display panel D4. On the front face of the display panel D4 is arranged a slit plate D3. The slit plate D3 is so arranged that viewers view the display panel D4 through the slit plate D3.

In FIG. 12, when a viewer views the display panel D4 from a viewpoint D61, the viewer can view the “a1” pixels D41, the “a2” pixels D42, and the “a3” pixels D43 through the slits of the slit plate D3 as indicated by lines of sight D51 and D52. That is, the viewer can view the first image from the viewpoint D61. Meanwhile, the “b1” pixels D44, the “b2” pixels D45, and the “b3” pixels D46 are blocked out of sight by the slit plate D3, and hence the viewer cannot view the second image from the viewpoint D61.

On the other hand, when a viewer views the display panel D4 from a viewpoint D62, the viewer can view the “b1” pixels D44, the “b2” pixels D45, and the “b3” pixels D46 through the slits of the slit plate D3 as indicated by lines of sight D53 and D54. That is, the viewer can view the second image from the viewpoint D62. Meanwhile, the “a1” pixels D41, the “a2” pixels D42, and the “a3” pixels D43 are blocked out of sight by the slit plate D3, and hence the viewer cannot view the first image from the viewpoint D62.

As described above, the dual-view display device D is so designed that a plurality of images are displayed simultaneously on the display panel D4 and one of those images can be viewed from a predetermined direction.

FIG. 13 is an outline enlarged front view of the display panel D4. The display panel D4 includes a first side portion D21 located along one side thereof, a central portion D22, and a second side portion D23 located along the other side thereof.

In the first side portion D21 are formed “a1” pixels D41 for the first image and “b1” pixels D44 for the second image. The “a1” pixels D41 and the “b1” pixels D44 are arranged adjacent to each other. With the display panel D4 seen from in front, the “a1” pixels D41 are arrayed in the up/down direction, and the “b1” pixels D44 are arrayed in the up/down direction.

Likewise, in the central portion D22, “a2” pixels D42 for the first image and “b2” pixels D45 for the second image are arrayed respectively in the up/down direction so as to be adjacent to each other. Likewise, in the second side portion D23, “a3” pixels D43 for the first image and “b3” pixels D46 for the second image are arrayed respectively in the up/down direction so as to be adjacent to each other.

As described above, the pixels for displaying the first image and the pixels for displaying the second image are arranged alternately in the left/right direction, with the display panel D4 seen from in front. The pixels are so formed as to have largely the same shape and area all over the display panel D4.

As a conventional technology related to what has been described thus far, there have been disclosed and proposed various stereoscopic image display devices comprising an image display that outputs separate image lights for the left and right eyes alternately and an optical separator that separates those image lights so as to direct them to the left and right eyes, respectively (for example, see Japanese Patent Application Laid-Open No. 2003-295113).

To be sure, with a dual-view display device structured as described above, it is possible to present a plurality of viewers with different images simultaneously, and thereby to give a single display device increased shareability.

However, in a conventional dual-view display device, the display panel is driven with no consideration given to whether or not images need to be outputted in a plurality of directions at all. That is, both the first pixels for outputting image light to be directed in the first viewing direction and the second pixels for outputting image light to be directed in the second viewing direction are kept driven all the time. Inconveniently, this results in a waste of electric power when the display device is viewed only from one direction.

Moreover, a conventional dual-view display device typically adopts an active-matrix display panel E1, which is configured as shown in FIG. 14. Specifically, there are arranged alternately m (m≧2) first pixel columns each including n (n≧2) first pixels (a₁₁ to a₁ₙ, . . . , aₘ₁ to aₘₙ) and m second pixel columns each including n second pixels (b₁₁ to b₁ₙ, . . . , bₘ₁ to bₘₙ). In the direction (the up/down direction as seen in the figure) of the columns, along each of which first or second pixels are arrayed contiguously, source lines (image signal lines) are provided so that each source line is common to all the pixels in one column. In the direction (the left/right direction as seen in the figure) of the rows, along each of which first and second pixels are arrayed alternately, gate lines (scanning signal lines) are provided so that each gate line is common to all the pixels in one row.

As described above, in a conventional dual-view display device, the first and second pixels in the same row are scanned collectively. Thus, even if the images to be outputted in the first and second viewing directions have different display frequencies (the frequencies at which image signals need to be fed in to maintain satisfactory display quality), it is not possible to set separate scanning frequencies (the frequencies at which the active elements need to be turned on) for the first and second pixels. Hence, the scanning frequencies for the first and second pixels are inevitably kept equal so as to accommodate the one for those pixels that are fed with image signals having a higher display frequency. p For example, in a case where a moving picture is displayed in the first viewing direction and a still picture is displayed in the second viewing direction, although the second pixels can display the still picture while maintaining satisfactory image quality even if fed with image signals only once for a plurality of frame periods, the active elements of the second pixels are unnecessarily turned on every frame period in conformity with the active elements of the first pixels, which need to be turned on every frame period to display the moving picture while maintaining satisfactory image.

Thus, in a conventional dual-view display device, the pixels for displaying images having a lower display frequency are fed with overquality image signals, resulting in a waste of electric power in a source line drive circuit E2.

Moreover, in the conventional dual-view display device shown in FIGS. 12 and 13, viewers standing at different angles with respect to the display panel D4 can view different images simultaneously. However, in FIG. 12, when a viewer views the first image from the viewpoint D61, since the distance from the viewpoint D61 to the “a2” pixel D42 differs from the distance from the viewpoint D61 to the “a3” pixel D43, inconveniently, the first image appears to be distorted. Likewise, when a viewer views the second image from the viewpoint D61, inconveniently, the second image appears to be distorted.

### SUMMARY OF THE INVENTION

In view of the conventionally encountered problems described above, it is a first object of the present invention to provide a display device that can present a plurality of viewers with different images simultaneously with minimum waste of electric power. It is a second object of the present invention to provide a display panel and a display device that can present a plurality of viewers with different images simultaneously with minimum distortion in the displayed image.

To achieve the first object noted above, in one aspect of the present invention, a display device is provided with: a display panel having first pixels for outputting image light to be directed in a first viewing direction and second pixels for outputting image light to be directed in a second viewing direction; a first drive circuit for driving the first pixels; a second drive circuit for driving the second pixels; and an optical separator arranged on the front face of the display panel for separating the image lights outputted from the first and second pixels so as to direct the image lights in the first and second viewing directions, respectively. Here, at least one of the first and second drive circuits includes: a shift register for shifting a start pulse in synchronism with a clock signal to generate a sampling pulse; a sampling circuit for sampling an image signal in synchronism with the sampling pulse; and a switch for controlling, according to a switch signal, whether or not to feed the clock signal to the shift register or whether or not to feed the start pulse to the shift register. The first and second pixels are driven by the use of the output signal of the sampling circuit.

To achieve the first object noted above, in another aspect of the present invention, a display device is provided with: an active-matrix display panel including: a plurality of source lines, a plurality of gate lines that cross the source lines, first pixels that output image light to be directed in a first viewing direction, and second pixels that output image light to be directed in a second viewing direction, the first and second pixels both having active elements of which sources are connected to the source lines, of which gates are connected to the gate lines, and of which drains are connected to pixel segment electrodes; a source line drive circuit for feeding an image signal to the source lines; a gate line drive circuit for feeding a scanning signal to the gate lines; and an optical separator arranged on the front face of the display panel for separating the image lights outputted from the first and second pixels to direct the image lights in the first and second viewing directions, respectively. Here, the display panel includes a plurality of first pixel columns each including a plurality of first pixels and a plurality of second pixel columns each including a plurality of second pixels and is so configured that, in the direction of the columns, along each of which first or second pixels are arrayed contiguously, gate lines are provided so that each gate line is connected commonly to all the pixels in one column and that, in the direction of rows, along each of which first and second pixels are arrayed alternately, source lines are provided so that each source line is connected commonly to all the pixels in one row.

To achieve the second object noted above, in still another aspect of the present invention, a display panel is provided with: a plurality of first pixels for displaying a first image that can be viewed from one of a leftward and a rightward directions with the display panel seen from in front; and a plurality of second pixels for displaying a second image that can be viewed from the other of the leftward and rightward directions. Here, of the first and second pixels, at least either the first or second pixels are so arranged as to have varying areas in the left/right direction.

### BRIEF DESCRIPTION OF THE DRAWINGS

FIG. 1 is an outline structure diagram showing, as a first embodiment, a dual-view display device (display device A) embodying the invention;

FIG. 2 is a circuit diagram showing a first example of the configuration of the display device A;

FIG. 3 is a circuit diagram showing a second example of the configuration of the display device A;

FIG. 4 is a circuit diagram showing a third example of the configuration of the display device A;

FIG. 5 is an outline structure diagram showing, as a second embodiment, a dual-view display device (display device B) embodying the invention;

FIG. 6 is a circuit diagram showing a first example of the configuration of the display device B;

FIG. 7 is a circuit diagram showing a second example of the configuration of the display device B;

FIG. 8 is a circuit diagram showing a third example of the configuration of the display device B;

FIG. 9 is a circuit diagram showing a fourth example of the configuration of the display device B;

FIG. 10 is an outline structure diagram showing, as a third embodiment, a dual-view display device (display device B) embodying the invention

FIGS. 11A and 11B are outline enlarged front views of the display panel C2;

FIG. 12 is an outline structure diagram showing a conventional dual-view display device;

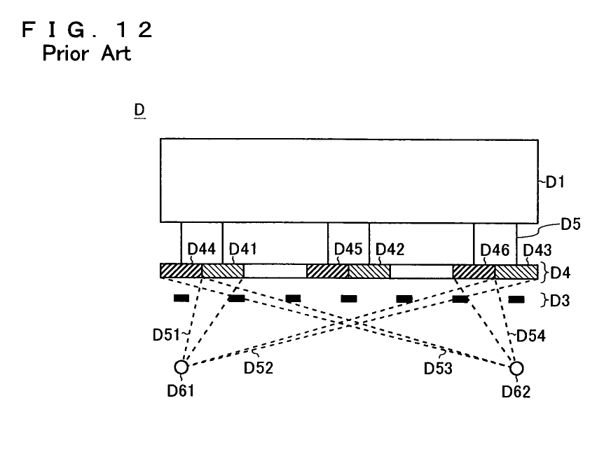

FIG. 13 is outline enlarged front view of the display panel D4; and

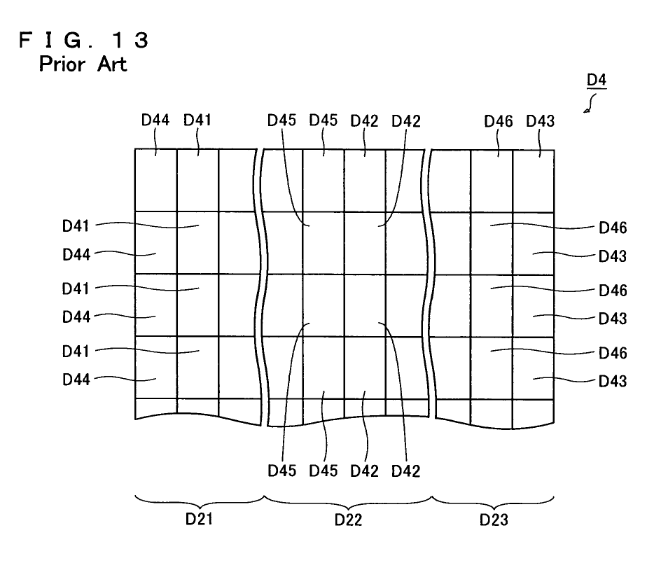

FIG. 14 is a diagram schematically showing the pattern in which first and second pixels are conventionally arrayed.

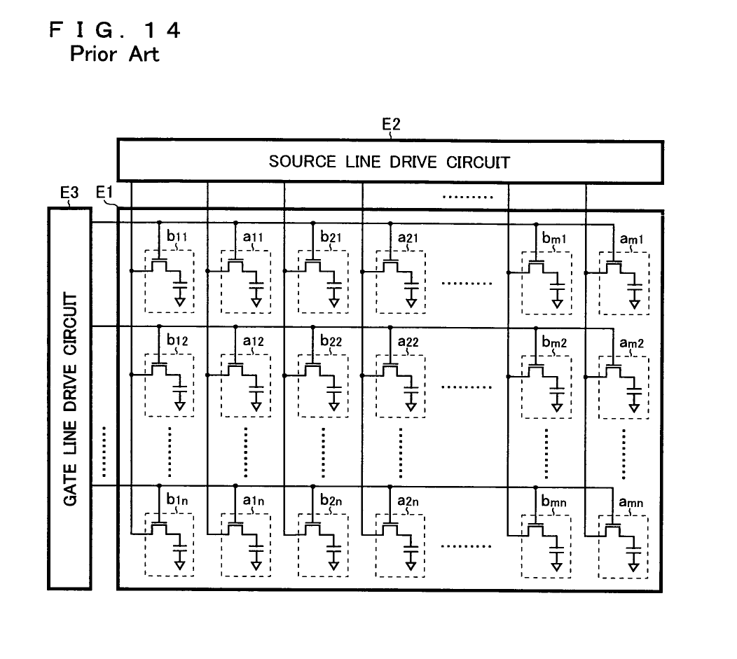

### DETAILED DESCRIPTION OF PREFERRED EMBODIMENTS

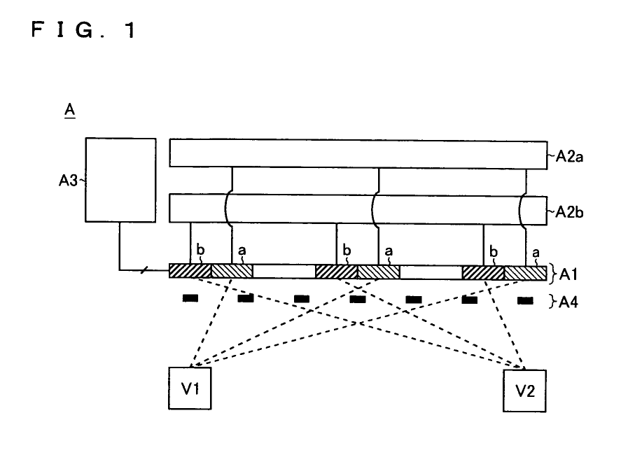

FIG. 1 is an outline structure diagram (outline sectional view) showing, as a first embodiment, a dual-view display device embodying the present invention. As shown in this figure, the display device A of this embodiment has: a display panel A1 including first pixels “a” that output image light to be directed in the first viewing direction (image light for a viewer V1) and second pixels “b” that output image light to be directed in the second viewing direction (image light for a viewer V2); a first source line drive circuit A2a that feeds source signals to the first pixels “a”; a second source line drive circuit A2b that feeds source signals to the second pixels “b”; a gate line drive circuit A3 that feeds gate signals to the first and second pixels “a” and “b”; and an optical separator A4 (in this embodiment, a slit plate) that separates the image lights outputted from the first and second pixels “a” and “b” so that they are directed in the first and second directions, respectively.

In the display device A configured as described above, in the first viewing direction (the direction in which the viewer V1 is located), only the image light outputted from the first pixels “a” is transmitted, and the image light outputted from the second pixels “b” is blocked. On the other hand, in the second viewing direction (the direction in which the viewer V2 is located), only the image light outputted from the second pixels “b” is transmitted, and the image light outputted from the first pixels “a” is blocked. This permits the viewers V1 and V2 to view different images simultaneously.

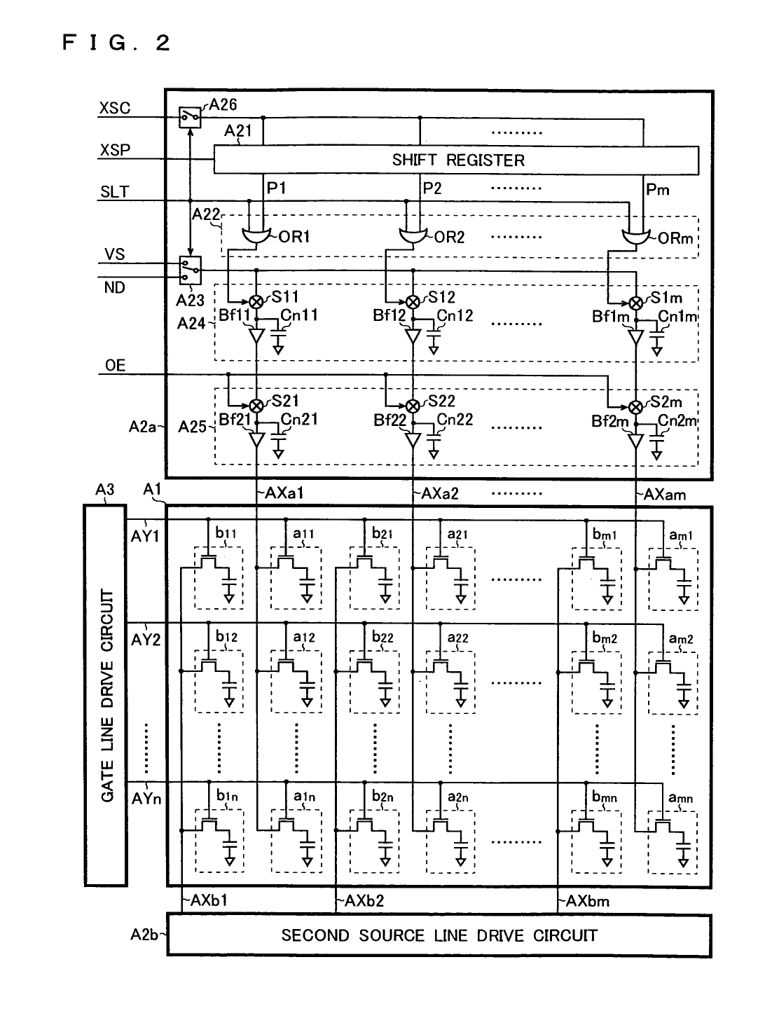

In the display device A configured as described above, it is the internal configuration of the first and second source line driver circuits A2a and A2b that is novel (distinctively different from conventional configurations). Now, with reference to FIGS. 2 to 4, a detailed description will be given of the internal configuration of the first and second source line driver circuits A2a and A2b.

FIG. 2 is a circuit diagram showing a first example of the configuration of the display A (in particular, the first source line drive circuit A2a). It should be noted that the second source line drive circuit A2b is configured likewise, and therefore no separate description of the configuration thereof will be given.

As shown in FIG. 2, in this example, the first source line drive circuit A2a has: a shift register A21 that generates sampling pulses P1 to Pm by shifting a start pulse XSP in synchronism with a clock pulse XSC; a logic gate circuit A22 that generates OR signals between the sampling pulses P1 to Pm and a switch signal SLT, which is a binary signal (taking either a high or a low level at a time); a selector A23 that outputs, according to the switch signal SLT, either an image signal (an analog signal for normal image display) or a non-display signal ND (in this embodiment, a black signal); a sampling circuit A24 that samples the output signal of the selector A23 according to the OR signals; a hold circuit A25 that holds the output signals of the sampling circuit A24 according to an output pulse OE; and a switch A26 that controls, according to the switch signal SLT, whether or not to feed the clock signal XSC to the shift register A21. The first source line drive circuit A2a drives the first pixels a₁₁ to aₘₙ by using the output signals of the sampling circuit A24 as held by the hold circuit A25.

The logic gate circuit A22 has OR circuits OR1 to Orm that receive, at one input terminals, the sampling pulses P1 to Pm and that receive, at the other input terminals, the switch signal SLT.

The sampling circuit A24 has: analog switches S11 to S1m of which the input ends are connected to the output end of the selector A23 and which are turned on and off according to the OR signals mentioned above; sampling capacitors Cn11 to Cn1m connected between the output ends of the analog switches S11 to S1m and a common electrode (for example, a ground electrode); and buffers Bf11 to Bf1m that are connected to the output ends of the analog switches S11 to S1m.

The hold circuit A25 has: analog switches S21 to S2m of which the input ends are connected to the output ends of the buffers Bf11 to Bf1m and which are turned on and off according to an output pulse OE; hold capacitor Cn21 to Cn2m that are connected between the output ends of the analog switches S21 to S2m and a common electrode (for example, a ground electrode); and buffers Bf21 to Bf2m that are connected to the output ends of the analog switches S21 to S2m.

In the display device A, an active-matrix panel (for example, a TFT (thin-film transistor) liquid crystal panel) is used as the display panel A1. Specifically, the display panel A1 has: m first source lines AXa1 to AXam to which the output signals of the first source line drive circuit A2a (the output signals of the hold circuit A25) are fed; m second source lines AXb1 to AXb1m to which the output signals of the second source line drive circuit A2b are fed; and n gate lines AY1 to AYn that cross the first and second source lines.

Near the intersections between the first source lines AXa1 to AXam and the gate lines AY1 to AYn are respectively formed (m×n) first pixels a₁₁ to aₘₙ, and near the intersections between the second source lines AXb1 to AXbm and the gate lines AY1 to AYn are respectively formed (m×n) second pixels b₁₁ to bₘₙ. The first pixels a₁₁ to aₘₙ respectively have active elements of which the sources are connected to the first source lines AXa1 to Axam, of which the gates are connected to the gate lines AY1 to AYn, and of which the drains are connected to pixel segment electrodes. The second pixels b₁₁ to bₘₙ respectively have active elements of which the sources are connected to the second source lines AXb1 to Axbm, of which the gates are connected to the gate lines AY1 to AYn, and of which the drains are connected to pixel segment electrodes.

Using as the display panel A1 an active-matrix panel rather than a passive-matrix panel in this way ensures that the individual pixels are lit without fail, making it possible to realize a clear display screen with fast response.

Now, the operation of the first source line drive circuit A2a configured as described above will be described in detail. First, consider the case where the first pixels a₁₁ to aₘₙ are brought into a normally driven state.

In this case, the signal level of the switch signal SLT is turned to a low level. This closes the switch A26, permitting the clock signal XSC to be fed to the shift register A21. Thus, the shift register A21 generates sampling pulses P1 to Pm. It should be noted that, while the signal level of the switch signal SLT is at a low level, the output signals of the OR circuits OR1 to ORm are identical with the sampling pulses P1 to Pm generated by the shift register A21. On the other hand, according to the switch signal SLT, the selector A23 selects an image signal VS and feeds it to the sampling circuit A24.

Thus, when the first pixels a₁₁ to aₘₙ are brought into a normally driven state, the sampling pulses P1 to Pm are fed to the analog switches S11 to S1m of the sampling circuit A24 so that these analog switches S11 to S1m are sequentially brought into a conducting state. As a result, the sampling capacitors Cn11 to Cn1m are sequentially charged with instantaneous amplitudes of the image signal VS.

On completion of the sequential charging of the sampling capacitors Cn11 to Cn1m as described above, which results in the sampling of the image signal VS in synchronism with the sampling pulses P1 to Pm during a single horizontal scanning period, an output pulse OE is fed to the hold circuit A25. This closes the analog switches S21 to S2m of the hold circuit A25 all at once so that the image signal VS with which the sampling capacitors Cn11 to Cn1m are charged are transferred through the buffers Bf11 to Bf1m to the hold capacitors Cn21 to Cn2m so as to be held therein. The image signal VS held in the hold capacitors Cn21 to Cn2m are then fed through the buffers Bf21 to Bf2m to the corresponding first source lines AXa1 to AXam.

On the other hand, the gate line drive circuit A3 feeds scanning signals synchronous with the horizontal scanning signal of the image signal VS to the gate lines AY1 to AYn so that the pixels connected to one gate line after another are brought into a conducting state.

Through the operation described above, the display panel A1 drives the first pixels a₁₁ to aₘₙ in their normally driven state and thereby outputs the image light to be directed in the first viewing angle (the image light for the viewer V1).

Next, consider the case where the first pixels a₁₁ to aₘₙ are brought into an undriven state (in other words, the case where the display device A is viewed only from the second viewing direction, or where it is not viewed from either direction).

In this case, the signal level of the switch signal SLT is turned to a high level. This opens the switches A26, prohibiting the clock signal XSC from being fed to the shift register A21. It should be noted that, while the signal level of the switch signal SLT is at a high level, the output signals of the OR circuits OR1 to ORm are kept at a high level irrespective of the output signals of the shift register A21. Thus, when the first pixels a₁₁ to aₘₙ are brought into an un-driven state, all the analog switches S11 to S1m are turned on. On the other hand, according to the switch signal SLT, the selector A23 selects a non-display signal ND and feeds it to the sampling circuit A24. Thus, the sampling capacitors Cn11 to Cn1m are charged with the non-display signal ND.

On completion of the charging of the sampling capacitors Cn11 to Cn1m as described above, an output pulse OE is fed to the hold circuit A25. This closes the analog switches S21 to S2m of the hold circuit A25 all at once so that the non-display signal ND with which the sampling capacitors Cn11 to Cn1m are charged are transferred through the buffers Bf11 to Bf1m to the hold capacitors Cn21 to Cn2m so as to be held therein. The non-display signal ND held in the hold capacitors Cn21 to Cn2m are then fed through the buffers Bf21 to Bf2m to the corresponding first source lines AXa1 to AXam.

On the other hand, the gate line drive circuit A3 feeds scanning signals synchronous with the horizontal scanning signal of the image signal VS to the gate lines AY1 to AYn so that the pixels connected to one gate line after another are brought into a conducting state.

Through the operation described above, the display panel A1 drives the first pixels a₁₁ to aₘₙ in their undriven state and thereby makes the screen appear entirely black in the first viewing angle.

As described above, in this display device A, at least one of the first source line drive circuit A2a, which feeds source signals to the first pixels a₁₁ to aₘₙ, or the second source line drive circuit A2b, which feeds source signals to the second pixels b₁₁ to bₘₙ, has: a shift register A21 that generates sampling pulses P1 to Pm by shifting a start pulse XSP in synchronism with a clock pulse XSC; a sampling circuit A24 that samples an image signal VS according to the sampling pulses P1 to Pm; and a switch A26 that controls, according to a binary switch signal SLT, whether or not to feed the clock signal XSC to the shift register A21. Moreover, the first pixels a₁₁ to aₘₙ and the second pixels b₁₁ to bₘₙ are driven by the use of the output signals of the sampling circuit A24.

With this configuration, even when the display device A is viewed only from one direction, or when it is not viewed from either direction, it is possible to stop the unnecessary generation of sampling pulses by the shift register A21 provided in the first source line drive circuit A2a and/or the second source line drive circuit A2b. This makes it possible to present a plurality of viewers with different images simultaneously with minimum waste of electric power.

In the display device A configured as described above, when either the first or second pixels a₁₁ to aₘₙ or b₁₁ to bₘₙ are brought into a normally driven state and the rest are brought into an undriven state, the pixels driven into an undriven state also needs to be fed with some potential. Otherwise, the source lines AY1 to AYn corresponding to the pixels in their undriven state have unstable potential levels, possibly adversely affecting the display obtained thereon (as with poorer display quality resulting from unexpected turning on and off of active elements, or from leak current to pixels whose active elements are in the off state).

In view of the above problem, in the display device A, at least one of the first and second source line drive circuits A2a and A2b has: a logic gate circuit A22 that generates OR signals between the sampling pulses P1 to Pm and the switch signal SLT; and a selector A23 that feeds, according to the switch signal SLT, either the image signal VS or the non-display signal ND to the sampling circuit A24. Here, the sampling circuit A24 samples the output signal of the selector A23 according to the OR signals mentioned above.

With this configuration, even when either the first or second pixels a₁₁ to aₘₙ or b₁₁ to bₘₙ are brought into a normally driven state and the rest are brought into an undriven state, the source lines AY1 to AYn corresponding to the pixels in their undriven state never have unstable potential levels. Thus, it is possible to prevent the display obtained thereon from being adversely affected.

The FIG. 2 discussed above deals with a case where a black signal is fed as the non-display signal ND. It should be understood, however, that the present invention may be implemented with any other configuration. Specifically, it is also possible to feed any other signal (such as a white signal). To prevent the first and second source line drive circuits A2a and A2b and the first and second pixels a₁₁ to aₘₙ and b₁₁ to bₘₙ are from being brought into a high-impedance state, however, it is preferable to feed as the non-display signal ND a voltage signal higher than a predetermined level.

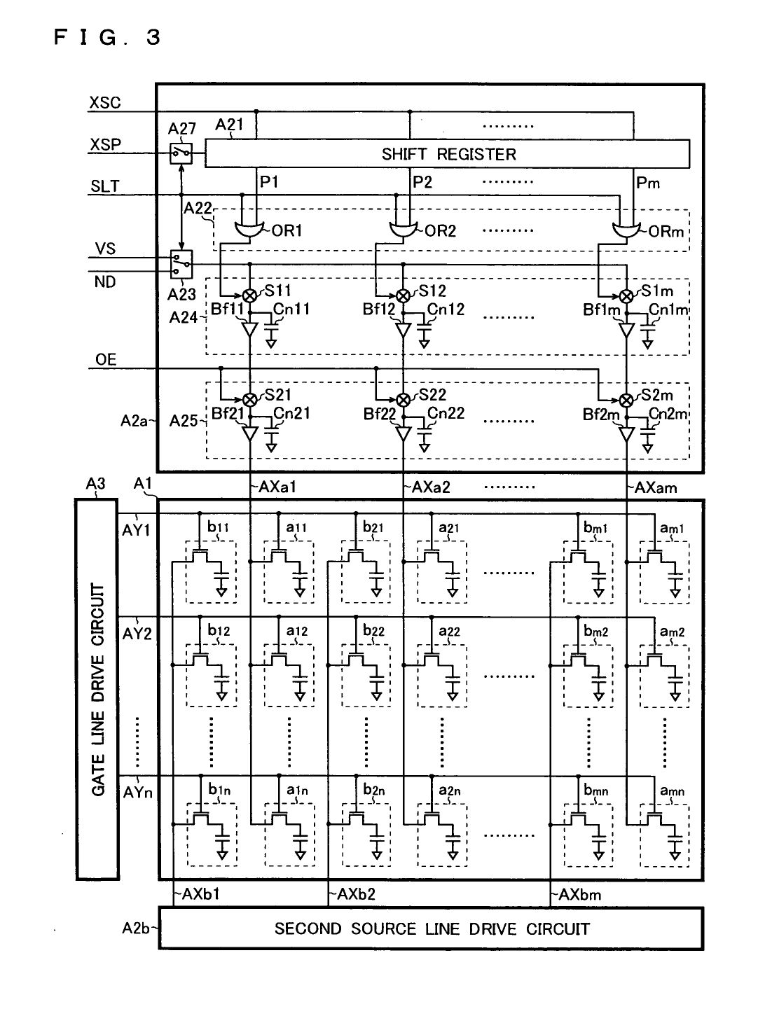

The FIG. 2 discussed above deals with a case where a switch A26 is provided that controls, according to the switch signal SLT, whether or not to feed the clock signal XSC to the shift register A21. It should be understood, however, that the present invention may be implemented with any other configuration. Specifically, effects similar to those obtained with the configuration described above can be obtained also in a case where, as shown in FIG. 3, a switch A27 is provided that controls, according to the switch signal SLT, whether or not to feed the start pulse XSP to the shift register A21.

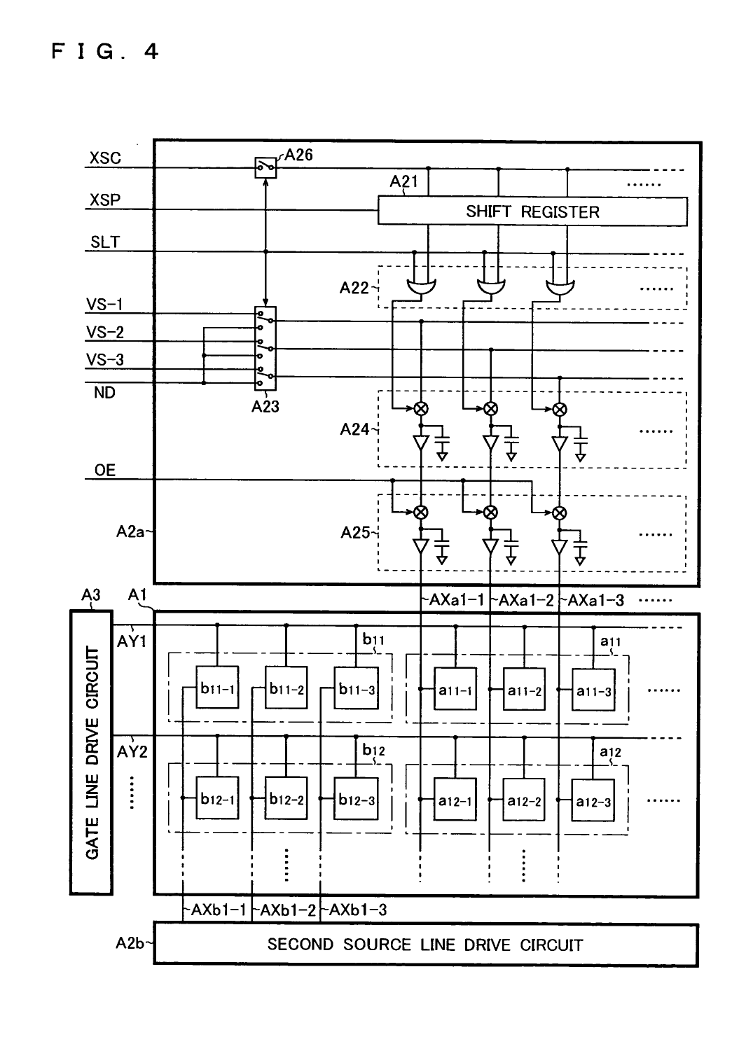

The FIG. 2 discussed above deals with a case where the first and second pixels a₁₁ to aₘₙ and b₁₁ to bₘₙ are each composed of a single pixel segment. It should be understood, however, that the present invention may be implemented with any other configuration. Specifically, it is also possible to adopt a configuration in which, as shown in FIG. 4, the first and second pixels a₁₁ to aₘₙ and b₁₁ to bₘₙ are each divided into a plurality of pixel segments (for example, three pixel segments, like pixel segments a₁₁₋₁ to a₁₁₋₃, b₁₁₋₁ to b₁₁₋₃, and so forth) and the selector A23 feeds either a plurality of image signals VS1 to VS3 fed in so as to correspond to the so divided plurality of pixel segments or the non-display signal ND to the sampling circuit A24. With this configuration, it is possible to increase the resolution of the display panel 1 and thereby enhance the expressive power of the display screen. Needless to say, the first and second pixels a₁₁ to aₘₙ and b₁₁ to bₘₙ may be divided into any other number of pixel segments, for example two, or four or more.

The FIG. 2 discussed above deals with a case where the first source line drive circuit A2a and the second source drive circuit A2b include, as constituent components thereof, a sampling circuit A24 and a hold circuit A25. It should be understood, however, that the present invention may be implemented with any other configuration. Specifically, it is also possible to adopt a configuration in which there is provided a sampling circuit A24 but no hold circuit A25. The sampling circuit A24 and the hold circuit A25 are not limited to those having sampling capacitors Cn11 to Cn1m and hold capacitors Cn21 to Cn2m and designed for an analog image signal, but may be those designed for a digital image signal.

Second Embodiment

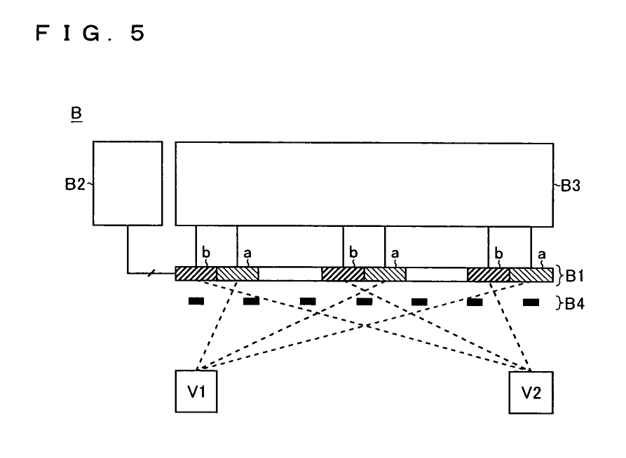

FIG. 5 is an outline structure diagram (outline sectional view) showing, as a second embodiment, a dual-view display device embodying the present invention. As shown in this figure, the display device B of this embodiment has: a display panel B1 including first pixels “a” that output image light to be directed in the first viewing direction (image light for a viewer V1) and second pixels “b” that output image light to be directed in the second viewing direction (image light for a viewer V2); a source line drive circuit B2 that feeds image signals to the first and pixels “a” and “b”; a gate line drive circuit B3 that feeds scanning signals to the first and second pixels “a” and “b”; and an optical separator B4 (in this embodiment, a slit plate) that separates the image lights outputted from the first and second pixels “a” and “b” so that they are directed in the first and second directions, respectively.

In the display device B configured as described above, in the first viewing direction (the direction in which the viewer V1 is located), only the image light outputted from the first pixels “a” is transmitted, and the image light outputted from the second pixels “b” is blocked. On the other hand, in the second viewing direction (the direction in which the viewer V2 is located), only the image light outputted from the second pixels “b” is transmitted, and the image light outputted from the first pixels “a” is blocked. This permits the viewers V1 and V2 to view different images simultaneously.

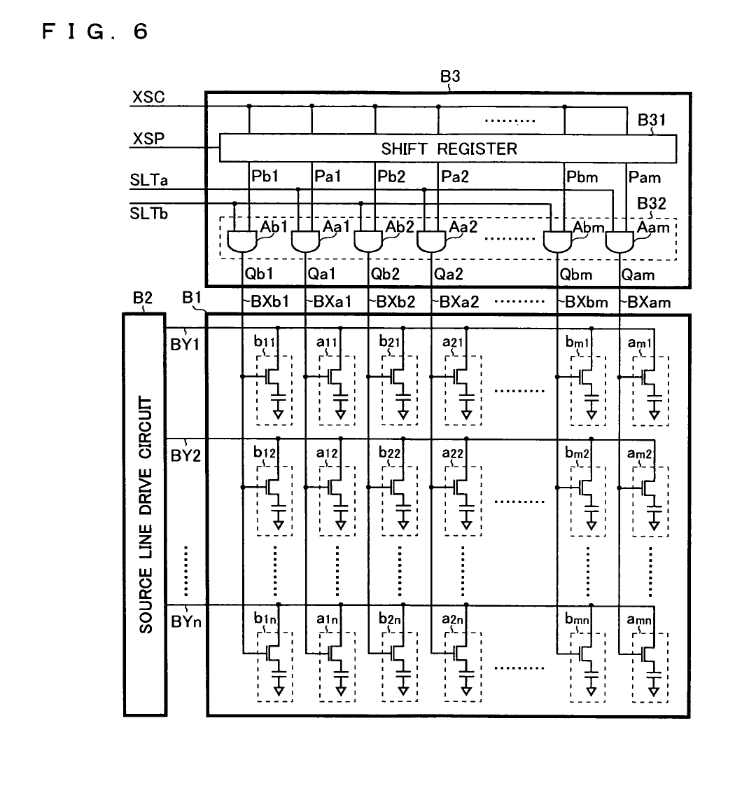

In the display device B configured as described above, it is the internal configuration of the display panel B1 and the gate line drive circuit B3 that is novel (distinctively different from conventional configurations). Now, with reference to FIGS. 6 to 9, a detailed description will be given of the internal configuration of those circuit blocks.

First, with reference to FIG. 6, a first example of the configuration of the display device B will be described in detail.

As shown in FIG. 6, in this example, the display device B uses an active matrix panel (for example, a TFT (thin-film transistor) liquid crystal panel) as the display panel B1.

Specifically, the display panel B1 has: m (m≧2) first gate lines BXa1 to BXam and m second gate lines BXb1 to BXbm to which scanning signals are fed from the gate line drive circuit B3; and n source lines BY1 to BYn to which image signals are fed from the source line drive circuit B2. Near the intersections between the first gate lines BXa1 to BXam and the source lines BY1 to BYn are respectively formed (m×n) first pixels a₁₁ to aₘₙ, and near the intersections between the second gate lines BXb1 to BXbm and the source lines BY1 to BYn are respectively formed (m×n) second pixels b₁₁ to bₘₙ. The first pixels a₁₁ to aₘₙ respectively have active elements of which the gates are connected to the first gate lines BXa1 to BXam, of which the sources are connected to the source lines BY to BYn, and of which the drains are connected to pixel segment electrodes. The second pixels b₁₁ to bₘₙ respectively have active elements of which the gates are connected to the second gate lines BXb1 to BXbm, of which the sources are connected to the source lines BY1 to BYn, and of which the drains are connected to pixel segment electrodes.

Using as the display panel B1 an active-matrix panel rather than a passive-matrix panel in this way ensures that the individual pixels are lit without fail, making it possible to realize a clear display screen with fast response.

Moreover, as will be understood from the foregoing, in the display panel B1 of this example, there are alternately arranged m (m≧2) first pixel columns (a₁₁ to a₁ₙ, . . . , aₘ₁ to aₘₙ) each consisting of n (n≧2) first pixels and m second pixel columns (b₁₁ to b₁ₙ, . . . , bₘ₁ to bₘₙ) each consisting of n second pixels. Here, in the direction (the vertical direction in the figure) of the columns, along each of which first or second pixels are arrayed contiguously, first and second gate lines BXa1 to BXam and BXb1 to BXbm are provided so that each gate line is connected commonly to all the pixels in one column and that, in the direction (the horizontal direction in the figure) of rows, along each of which first and second pixels are arrayed alternately, source lines BY1 to BYn are provided so that each source line is connected commonly to all the pixels in one row.

That is, in the display panel B1 of this example, in the direction of the columns, along each of which first or second pixels are arrayed contiguously, the lines that are each connected commonly to all the pixels in one column are not source lines (image signal lines) but gate lines (scanning signal lines), and in the direction of rows, along each of which first and second pixels are arrayed alternately, the lines that are each connected commonly to all the pixels in one row are not gate lines but source lines. In this respect, this configuration is distinctively different from conventional configurations, and is thus novel.

With this configuration, the gate line drive circuit B3 can stop the feeding of scanning signals to the first and to the second pixels individually. In other words, the gate line drive circuit B3 permits the scanning frequency to be set separately for the first pixels and for the second pixels.

Thus, in a case where the display device B is viewed only from one direction, or it is not viewed from either direction, or in a case where the display frequency of the images to be outputted in the first and second viewing directions are different, it is possible to stop the feeding of scanning signals to those pixels (non-display pixels or lower-display-frequency pixels) which do not require the updating of what is being displayed thereon and let them maintain the image signals previously written thereto without feeding them with new image signals.

In this way, it is possible to stop the generation of unnecessary image signals (the generation of image signals for those pixels which do not require the updating of what is being displayed thereon) by the source line drive circuit B2, and thereby to present a plurality of viewers with different images simultaneously with minimum waste of electric power.

The source line drive circuit B2 described above can be realized with a conventionally known configuration, and therefore no detailed description will be given of the internal configuration and operation thereof. It should be noted, however, that, as described above, in the display device B of this embodiment, the connections between the source and gate lines and the first and second pixels are made the other way around than in conventional configurations. Thus, to obtain correct display result on the display panel B1 configured as described above, the order in which image signals are fed to the first and second pixels needs to be rearranged beforehand. To achieve this, i.e., to permit such rearrangement of image signals, the source line drive circuit B2 is provided with a memory for temporarily storing the image signals fed thereto, and is so configured as to rearrange what is stored therein before feeding it out.

On the other hand, in this example, the gate line drive circuit B3 has: a shift register B31 that generates first and second scanning signals Pa1 to Pam and Pb1 to Pbm by shifting a start pulse XSP in synchronism with a clock signal XSC; and a logic gate circuit B32 that generates first and second AND signals Qa1 to Qam and Qb1 to Qbm by performing AND operation between the first and second scanning signals Pa1 to Pam and Pb1 to Pbm and a first and a second switch signal SLTa and SLTb, which each is a binary signal (taking either a high or a low level at a time). As the scanning signal to the display panel B1, the first AND signals Qa1 to Qam and are fed to the first pixel columns (a₁₁ to a₁ₙ, . . . , aₘ₁ to aₘₙ), and the second AND signals Qb1 to Qbm and are fed to the second pixel columns (b₁₁ to b₁ₙ, . . . , bₘ₁ to b_{mn).}

The logic gate circuit B32 has: m first AND circuits Aa1 to Aam that receive, at one input ends, the first scanning signals Pa1 to Pam and that receive, at the other input ends, the first switch signal SLTa; and m second AND circuits Ab1 to Abm that receive, at one input ends, the second scanning signals Pb1 to Pbm and that receive, at the other input ends, the second switch signal SLTb. Though not illustrated in FIG. 6, amplifiers, waveform shaping circuits, or the like may be provided in the output stages of the first and second AND circuits Aa1 to Aam and Ab1 to Abm.

With the gate line drive circuit B3 configured as described above, it is possible to stop the feeding of scanning signal to the first pixels and to the second pixels individually without having to unnecessarily increasing the circuit scale, and thus with a simple configuration.

Now, the operation of the gate line drive circuit B3 configured as described above will be described in detail. First, consider the case where only what is displayed on the first pixels a₁₁ to aₘₙ is updated while what is displayed on the second pixels b₁₁ to bₘₙ is not.

In this case, the signal level of the first switch signal SLTa is turned to a high level, and the signal level of the second switch signal SLTb is turned to a low level. This makes the first AND signals Qa1 to Qam generated by the first AND circuits Aa1 to Aam identical with the first scanning signal Pa1 to Pam generated by the shift register B31. On the other hand, the second AND signals Qb1 to Qbm generated by the second AND circuits Ab1 to Abm are kept at a low level irrespective of the second scanning signal Pb1 to Pbm generated by the shift register B31.

Thus, the first AND signals Qa1 to Qam (identical with the first scanning signal Pal to Pam) synchronous with the horizontal synchronizing signal of the image signals fed to the first pixels a₁₁ to aₘₙ are fed to the first gate lines BXa1 to BXam so that the first pixel columns (a₁₁ to a₁ₙ, . . . , aₘ₁ to aₘₙ) of which each is connected commonly to one gate line are brought into a conducting state one column after another. Meanwhile, the low-level second AND signals Qb1 to Qbm fed to the second gate lines BXb1 to BXbm bring the second pixel columns (b₁₁ to b₁ₙ, . . . , bₘ₁ to bₘₙ), which do not require the updating of what is being displayed thereon, into an undriven state.

On the other hand, the source line drive circuit B2 generates only the image signals to be fed to the first pixels a₁₁ to aₘₙ, and these image signals are fed to the source lines BY1 to BYn.

Through the operation described above, in the display panel B1, only what is displayed on the first pixels a₁₁ to aₘₙ is updated, while what has previously been displayed on the second pixels b₁₁ to bₘₙ is maintained so that no new image signals need to be fed thereto.

Next, consider the case where only what is displayed on the second pixels b₁₁ to bₘₙ is updated while what is displayed on the first pixels a₁₁ to aₘₙ is not.

In this case, the signal level of the first switch signal SLTa is turned to a low level, and the signal level of the second switch signal SLTb is turned to a high level. This makes the second AND signals Qb1 to Qbm generated by the second AND circuits Ab1 to Abm identical with the second scanning signal Pb1 to Pbm generated by the shift register B31. On the other hand, the first AND signals Qal to Qam generated by the first AND circuits Aa1 to Aam are kept at a low level irrespective of the first scanning signal Pa1 to Pam generated by the shift register B31.

Thus, the second AND signals Qb1 to Qbm (identical with the second scanning signal Pb1 to Pbm) synchronous with the horizontal synchronizing signal of the image signals fed to the first pixels b₁₁ to bₘₙ are fed to the second gate lines BXb1 to BXbm so that the second pixel columns (b₁₁ to b₁ₙ, . . . , bₘ₁ to bₘₙ) of which each is connected commonly to one gate line are brought into a conducting state one column after another. Meanwhile, the low-level first AND signals Qa1 to Qam fed to the first gate lines BXa1 to BXam bring the first pixel columns (a₁₁ to a₁ₙ, . . . , aₘ₁ to aₘₙ), which do not require the updating of what is being displayed thereon, into an undriven state.

On the other hand, the source line drive circuit B2 generates only the image signals to be fed to the second pixels b₁₁ to bₘₙ, and these image signals are fed to the source lines BY1 to BYn.

Through the operation described above, in the display panel B1, only what is displayed on the second pixels b₁₁ to bₘₙ is updated, while what has previously been displayed on the first pixels a₁₁ to aₘₙ is maintained so that no new image signals need to be fed thereto.

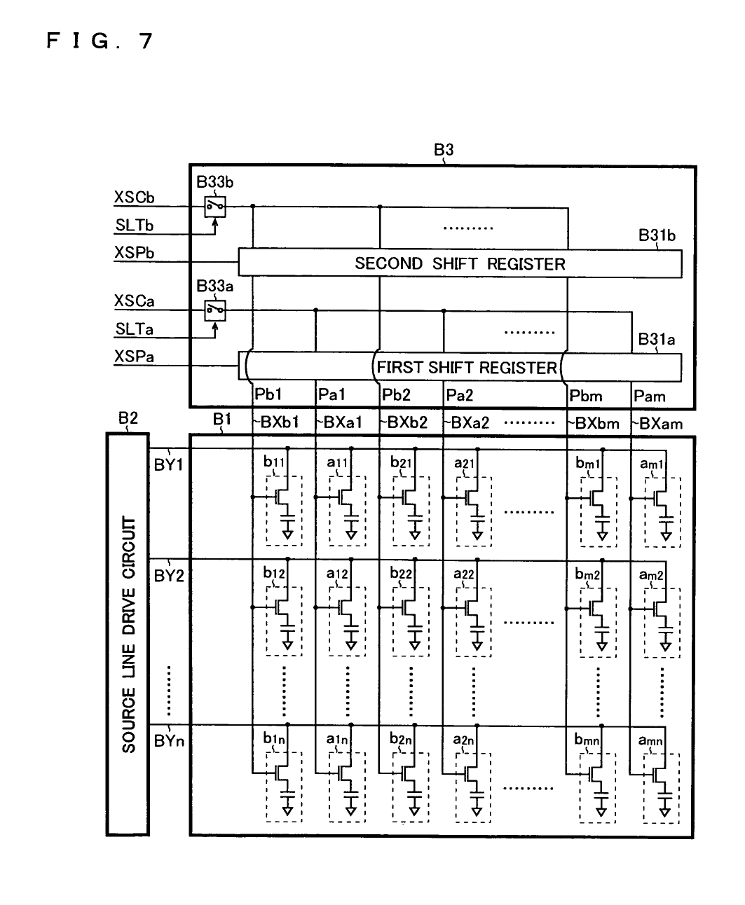

Next, with reference to FIG. 7, a second example of the configuration of the display device B will be described in detail. The display device B of this example has largely the same configuration as the display device B of the first example described above, and differs therefrom in the internal configuration of the gate line drive circuit B3. Therefore, here, such circuit elements and blocks as find their counterparts in the first example are identified with the same reference numerals and symbols as used in FIG. 6, and the following description proceeds with a special emphasis placed on the internal configuration of the gate line drive circuit B3.

As shown in FIG. 7, in this example, the gate line drive circuit B3 has: a first shift register B31a that generates first scanning signals Pa1 to Pam by shifting a first start pulse XSPa in synchronism with a first clock signal XSCa; a second shift register B31b that generates second scanning signals Pb1 to Pbm by shifting a second start pulse XSPb in synchronism with a second clock signal XSCb; a first switch B33a that controls, according to a first switch signal SLTa, whether or not to fed the first clock signal XSCa to the first shift register B31a; and a second switch B33b that controls, according to a second switch signal SLTb, whether or not to fed the second clock signal XSCb to the second shift register B31b. Here, as scanning signals, the first scanning signals Pa1 to Pam are fed to first pixel columns (a₁₁ to a₁ₙ, . . . , aₘ₁ to aₘₙ), and the second scanning signals Pb1 to Pbm are fed to second pixel columns (b₁₁ to b₁ₙ, . . . , bₘ₁ to bₘₙ). Though not illustrated in FIG. 7, amplifiers, waveform shaping circuits, or the like may be provided in the output stages of the first and second shift registers B31a and B31b.

With the gate line drive circuit B3 configured as described above, when stopping the feeding of scanning signals to the first or second pixels, it is possible to stop the operation of the first or second shift register B31a or B31b itself. This makes it possible to minimize the waste of electric power in the gate line drive circuit B3.

Now, the operation of the gate line drive circuit B3 configured as described above will be described in detail. First, consider the case where only what is displayed on the first pixels a₁₁ to aₘₙ is updated while what is displayed on the second pixels b₁₁ to bₘₙ is not.

In this case, according to the first switch signal SLTa, the first switch B33a is closed, permitting the first clock signal XSCa to be fed to the first shift register B31a. On the other hand, according to the second switch signal SLTb, the second switch B33b is opened, prohibiting the second clock signal XSCb from being fed to the second shift register B31b.

Thus, the first scanning signal Pa1 to Pam synchronous with the horizontal synchronizing signal of the image signals fed to the first pixels a₁₁ to aₘₙ are fed to the first gate lines BXa1 to BXam so that the first pixel columns (a₁₁ to a₁ₙ, . . . , aₘ₁ to aₘₙ) of which each is connected commonly to one gate line are brought into a conducting state one column after another. Meanwhile, the low-level second scanning signals Pb1 to Pbm fed to the second gate lines BXb1 to BXbm bring the second pixel columns (b₁₁ to b₁ₙ, . . , bₘ₁ to bₘₙ), which do not require the updating of what is being displayed thereon, into an undriven state.

On the other hand, the source line drive circuit B2 generates only the image signals to be fed to the first pixels a₁₁ to aₘₙ, and these image signals are fed to the source lines BY1 to BYn.

Through the operation described above, in the display panel B1, only what is displayed on the first pixels a₁₁ to aₘₙ is updated, while what has previously been displayed on the second pixels b₁₁ to bₘₙ is maintained so that no new image signals need to be fed thereto.

Next, consider the case where only what is displayed on the second pixels b₁₁ to bₘₙ is updated while what is displayed on the first pixels a₁₁ to aₘₙ is not.

In this case, according to the first switch signal SLTa, the first switch B33a is opened, prohibiting the first clock signal XSCa from being fed to the first shift register B31a. On the other hand, according to the second switch signal SLTb, the second switch B33b is closed, permitting the second clock signal XSCb to be fed to the second shift register B31b.

Thus, the second scanning signal Pb1 to Pbm synchronous with the horizontal synchronizing signal of the image signals fed to the second pixels b₁₁ to bₘₙ are fed to the second gate lines BXb1 to BXbm so that the second pixel columns (b₁₁ to b₁ₙ, . . . , bₘ₁ to bₘₙ) of which each is connected commonly to one gate line are brought into a conducting state one column after another. Meanwhile, the low-level first scanning signals Pa1 to Pam fed to the first gate lines BXa1 to BXam bring the first pixel columns (a₁₁ to a₁ₙ, . . . , aₘ₁ to aₘₙ), which do not require the updating of what is being displayed thereon, into an undriven state.

On the other hand, the source line drive circuit B2 generates only the image signals to be fed to the second pixels b₁₁ to bₘₙ, and these image signals are fed to the source lines BY1 to BYn.

Through the operation described above, in the display panel B1, only what is displayed on the second pixels b₁₁ to bₘₙ is updated, while what has previously been displayed on the first pixels a₁₁ to aₘₙ is maintained so that no new image signals need to be fed thereto.

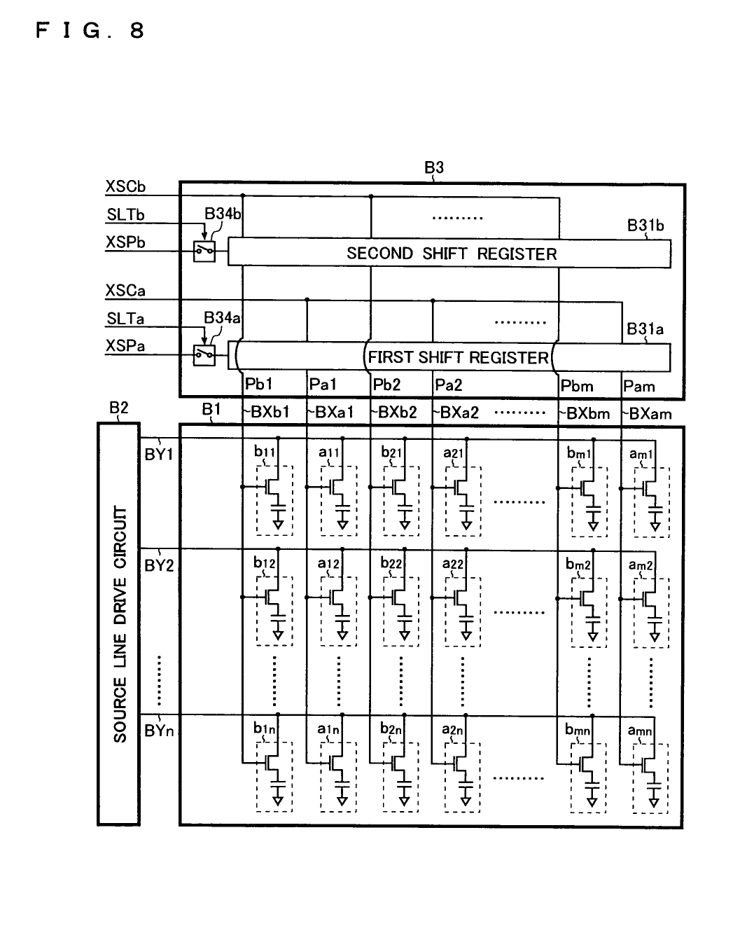

The second example discussed above deals with a case where a first and a second switch B33a and B33b are provided that control, according to the first and second switch signals SLTa and SLTb, whether or not to feed the first and second clock signals XSCa and XSCb to the first and second registers B31a and B31b. It should be understood, however, that the present invention may be implemented with any other configuration. Specifically, effects similar to those obtained with the configuration described above can be obtained also in a case where, as shown in FIG. 8, a first and a second switch B34a and B34b are provided that control, according to the first and second switch signals SLTa and SLTb, whether or not to feed the first and second start pulses XSPa and XSPb to the first and second registers B31a and B31b.

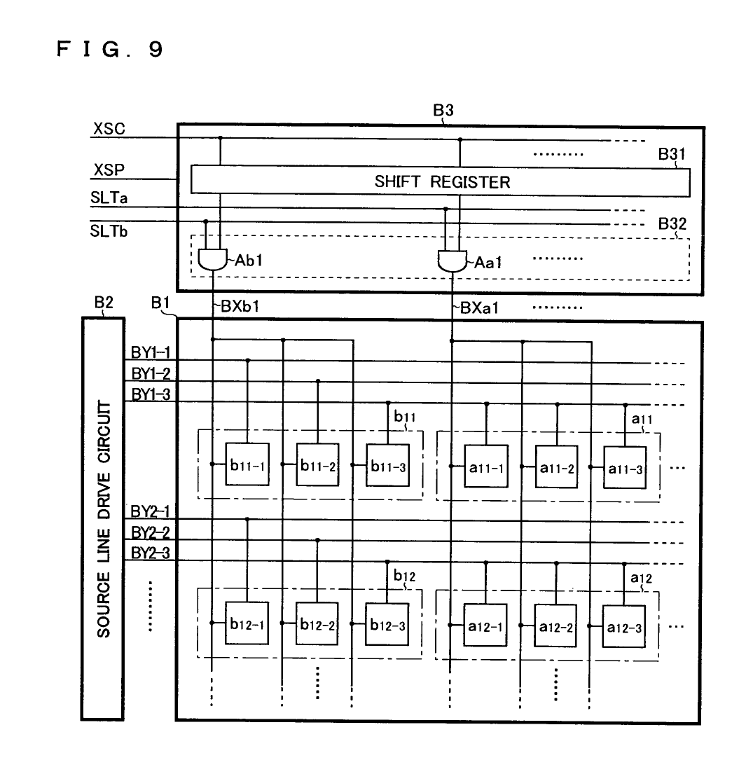

The first and second examples discussed above deals with a case where the first and second pixels a₁₁ to aₘₙ and b₁₁ to bₘₙ are each composed of a single pixel segment. It should be understood, however, that the present invention may be implemented with any other configuration. Specifically, it is also possible to adopt a configuration in which, as shown in FIG. 9, the first and second pixels a₁₁ to aₘₙ and b₁₁ to bₘₙ are each divided into a plurality of pixel segments (for example, three pixel segments, like pixel segments a₁₁₋₁ to a₁₁₋₃, b₁₁₋₁ to b₁₁₋₃, and so forth) and the source line drive circuit B2 feeds a plurality of image signals corresponding to the so divided plurality of pixel segments to the first and second pixels a₁₁ to aₘₙ and b₁₁ to bₘₙ. With this configuration, it is possible to increase the resolution of the display panel B1 and thereby enhance the expressive power of the display screen. Needless to say, the first and second pixels a₁₁ to aₘₙ and b₁₁ to bₘₙ may be divided into any other number of pixel segments, for example two, or four or more.

The first and second examples discussed above deal with a case where the first pixel columns (a₁₁ to a₁ₙ, . . . , aₘ₁ to aₘₙ) and the second pixel columns (b₁₁ to b₁ₙ, . . . , bₘ₁ to bₘₙ) are arranged alternately every single line. It should be understood, however, that the present invention may be implemented with any other configuration. Specifically, the first and second pixel columns may be arranged alternately with a plurality of first or second pixel columns occupying as many consecutive columns in part or the whole of the display panel.

Third Embodiment

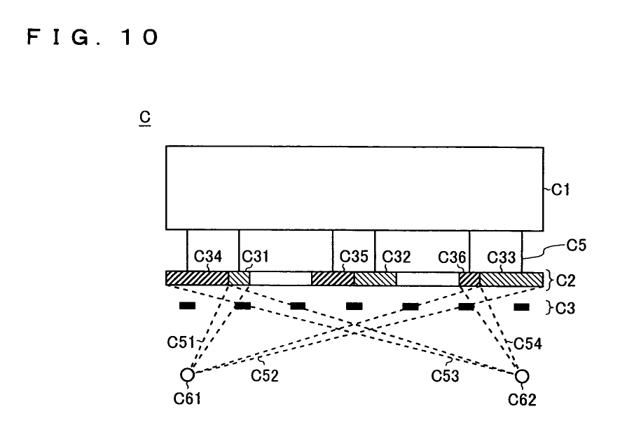

FIG. 10 is an outline structure diagram (outline sectional view) showing, as a third embodiment, a dual-view display device embodying the present invention. As shown in this figure, the display device C of this embodiment has: a display panel C2; and a driver C1 that drives the pixels formed on the display panel C2. The display device C further has an optical separator C3 (in this embodiment, a slit plate) arranged on the front face of the display panel C2.

The display panel C2 has: first pixels that display a first image when viewed from a viewpoint C61 located at one side of the front face; and second pixels that display a second image when viewed from a viewpoint C62 located at the other side of the front face. In this embodiment, “one side” denotes the left-hand side of the display panel C2 as seen from in front, and the “other side” denotes the right-hand side. The first pixels include “a1” pixels C31, “a2” pixels C32, and “a3” pixels C33. The second pixels include “b1” pixels C34, “b2” pixels C35, and “b3” pixels C36.

The slit plate C3 is so formed that, when the display panel C2 is viewed from the viewpoint C61, the first pixels can be viewed but the second pixels are hidden by the slit plate C3, and that, when the display panel C2 is viewed from the viewpoint C62, the second pixels can be viewed but the first pixels are hidden by the slit plate C3.

In this embodiment, the driver C1 includes an image signal circuit for driving the first pixels and an image signal circuit for driving the second pixels. That is, the single driver C1 drives the first and second pixels separately. The driver C1 is electrically connected to the display panel C2 via a connector C5.

In the display device C of this embodiment, of the first and second pixels of the display panel C2, at least either the first or second pixels are so formed as to have varying areas in the left/right direction with the display device C seen from in front (hereinafter simply the “left/right direction”). In this embodiment, as the first pixels, the “a1” pixels C31, the “a2” pixels C32, and the “a3” pixels C33 are so formed as to have gradually increasing areas from left to right in the left/right direction. That is, the first pixels are so formed that, when viewed from the viewpoint C61, the “a1” pixels C31, located relatively close to the viewpoint C61, have a relatively small area and the “a3” pixels C33, located relatively far away from the viewpoint C61, have a relatively large area.

On the other hand, the second pixels are so formed as to have gradually increasing areas from right to left in the left/right direction. That is, the “b3” pixels C36, the “b2” pixels C35, and the “b1” pixels C34 are so formed as to have gradually increasing areas from right to left. Specifically, the second pixels are so formed that, when viewed from the viewpoint C62, the “b3” pixels C36, located relatively close to the viewpoint C62, have a relatively small area and the “b1” pixels C34, located relatively far away from the viewpoint C62, have a relatively large area.

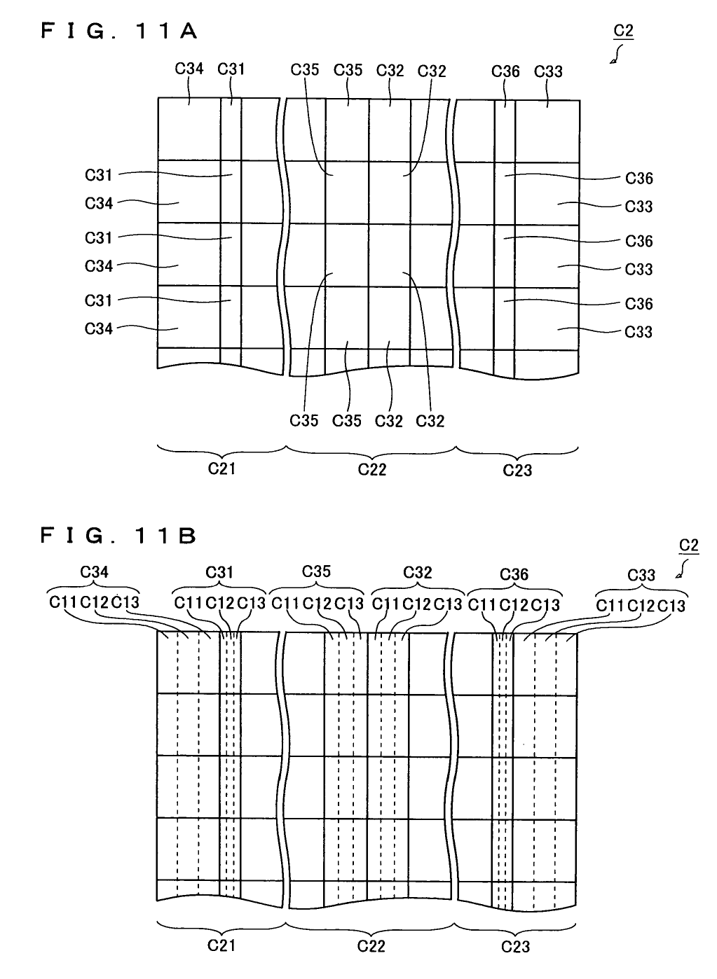

FIGS. 11A and 11B are outline enlarged front views of the display panel C2 as seen from in front. FIG. 11A is a diagram illustrating the individual pixels of the display panel C2. The display panel C2 includes a first side portion C21 located along the left-hand side thereof, a central portion C22 located substantially along the middle thereof, and a second side portion C23 located along the right-hand side thereof. In all these regions, the first and second pixels are arranged alternately in the left/right direction. That is the first and second pixels are arranged adjacent to each other. The first and second pixels are respectively arrayed in the up/down direction with the display device C seen from in front.

The first pixels are so formed as to have gradually increasing widths from left to right in the left/right direction. Specifically, the first pixels are so formed that the “a2” pixels C32 have a larger width than the “a1” pixels C31, and that the “a3” pixels C33 have a larger width than the “a2” pixels C32. Moreover, the pixels are so formed as to have constant heights in the direction of the height of the display panel C2.

The second pixels are so formed as to have gradually increasing widths from right to left in the left/right direction. Specifically, the first pixels are so formed that the “b2” pixels C35 have a larger width than the “b3” pixels C36, and that the “b1” pixels C34 have a larger width than the “b2” pixels C35. In this way, in this embodiment, the pixels have varying widths in the right/left direction so as to have varying areas in that direction.

Moreover, in this embodiment, the pixels are so formed that the sum of the areas of every two mutually adjacent and corresponding first and second pixels is substantially constant in the left/right direction of the display panel C2. For example, in the display panel C2, the pixels are so formed that the sum of the areas of the “a1” pixels C31 and the “b1” pixels C34 is substantially equal to the sum of the areas of the “a2” pixels C32 and the “b2” pixels C35, and to the sum of the areas of the “a3” pixels C33 and the “b3” pixels C36.

FIG. 11B is a diagram illustrating the pixel segments included in the individual pixels. As shown in FIG. 11B, in the display panel C2 of this embodiment, each pixel is divided into three segments by division lines parallel to the up/down direction with the display panel C2 seen from in front. Each pixel includes a first pixel region C11, a second pixel region C12, and a third pixel region C13. In each pixel, the three pixel segments correspond to R, G, and B. In this way, in this embodiment, one pixel includes three pixel segments.

The configuration of the third embodiment provides the following effects and advantages.

As shown in FIG. 10, the display panel C2 of this embodiment includes first pixels and second pixels, of which either the first or second pixels are so formed as to have varying areas in the left/right direction. With this structure, it is possible to reduce the distortion appearing in the respective images.

More specifically, as shown in FIG. 10, the pixels are so formed that, when the display panel C2 is viewed from the viewpoint C61, the “a1” pixels C31, which correspond to the line of sight C51 along which the distance to the pixels is relatively small, have a relatively small area and the “a3” pixels C33, which correspond to the line of sight C52 along which the distance to the pixels is relatively great, have a relatively large area. With this structure, it is possible to reduce the distortion that appears in the first image when it is viewed from the viewpoint C61 on account of the difference in the distance from the viewer to the pixels.

Moreover, the pixels are so formed that the “b1” pixels C34, which is relatively far away from the viewpoint C62, have a relatively large area and the “b3” pixels C36, which are relatively close to the viewpoint C62, have a relatively small area. With this structure, it is possible to reduce the distortion that appears in the second image when it is viewed from the viewpoint C62.

In this embodiment, the first and second pixels are respectively so formed as to have gradually varying areas in the left/right direction.

As exemplified by the “a1” pixels C31, the “a2” pixels C32, and the “a3” pixels C33, the first pixels are so formed as to have gradually increasing areas from left to right in the left/right direction. With this structure, it is possible to prevent the first image from being distorted.

Likewise, as exemplified by the “b1” pixels C34, the “b2” pixels C35, and the “b3” pixels C36, the second pixels are so formed as to have gradually increasing areas from right to left in the left/right direction. With this structure, it is possible to prevent the second image from being distorted.

In this embodiment, the pixels are so formed as to have gradually varying areas in the left/right direction. It is, however, possible to adopt any other structure. For example, it is possible to form the pixels so that they have a constant area within the first side portion C21, i.e., the left-hand region in the left/right direction, that they have a constant area within the central portion C22, and that they have a constant area within the second side portion C23, i.e., the right-hand region.

In that case, for example, in FIGS. 11A and 11B, the pixels are, with respect to the first image, so formed that the first pixels located in the central portion C22 have a larger area than those located in the first side portion C21, and that the first pixels located in the second side portion C23 have a larger area than those located in the central portion C22

Moreover, in this embodiment, the first and second pixels are so formed that the sum of the areas of every two mutually adjacent and corresponding first and second pixels is substantially constant all over the display panel C2. With this construction, it is possible to remove the display panel C2 from the front face of the display panel C2 and use the display device C as a common display device for displaying a single image at a time. That is, the corresponding first and second pixels are combined together so that the display device C is used as a display device that displays a single image over the entire display panel C2. Here, the expression “substantially constant” denotes that the above-mentioned sum is constant to such a degree that no distortion is observed in the single image so displayed.

In the display panel C2 of this embodiment, the first and second pixels are each divided into a plurality of pixel segments. With this structure, it is possible to display the first and second images in color. In this embodiment, three picture segments are formed in a single pixel. It is, however, also possible to divide each pixel into any other number, more than one, of pixel segments. In this embodiment, both the first and second pixels are divided into three pixel segments. It is, however, also possible to divide only either the first or second pixels. For example, it is possible to divide the first pixels so that the first image is displayed in color while leaving the second pixels undivided so that the second image is displayed in black and white.

In this embodiment, a single driver C1 is formed to drive both the first and second pixels. It is, however, also possible to form a plurality of drivers to drive them individually. That is, the first or second embodiment may be combined appropriately with the third embodiment.

In the present invention, it is possible to use any type of display panel C2 other than those specifically described above. For example, it is possible to use any type of display panel having pixels, such as a liquid crystal display panel, an electroluminescence display, or the like.

In this embodiment, the pixels are so formed as to have varying areas in the left/right directions. It is, however, also possible to form the pixels so that they have varying areas in the up/down direction with the display panel seen from in front. With this structure, it is possible to reduce the distortion appearing in the images viewed from different viewpoints located at different angles in the up/down direction. It is possible even to form the pixels so that they have varying areas in an oblique direction with the display panel seen from in front. With this structure, it is possible to reduce the distortion appearing in the images viewed from different viewpoints located at different angles in the oblique direction.

It should be understood that the embodiments described above are all merely examples of how the present invention is implemented and are not meant to limit it in any way. Thus, many modifications and variations are possible within the spirit of the present invention. The technical scope of the present invention is not limited to what has been specifically described above, but is recited in the appended claims, and includes any modifications and variations made in the sense and within the scope equivalent to what is recited in the claims.

1. A display device comprising:
a display panel having first pixels for outputting image light to be directed in a first viewing direction and second pixels for outputting image light to be directed in a second viewing direction;
a first drive circuit for driving the first pixels;
a second drive circuit for driving the second pixels; and
an optical separator arranged on a front face of the display panel for separating the image lights outputted from the first and second pixels so as to direct the image lights in the first and second viewing directions, respectively,
wherein at least one of the first and second drive circuits includes:
a shift register for shifting a start pulse in synchronism with a clock signal to generate a sampling pulse;
a sampling circuit for sampling an image signal in synchronism with the sampling pulse; and
a switch for controlling, according to a switch signal, whether or not to feed the clock signal to the shift register or whether or not to feed the start pulse to the shift register, and
wherein the first and second pixels are driven by use of an output signal of the sampling circuit.

2. The display device of claim 1,
wherein the at least one of the first and second drive circuits further includes:
a logic gate circuit for generating an OR signal between the sampling pulse and the switch signal; and
a selector for feeding, according to the switch signal, either the image signal or a non-display signal to the sampling circuit, and
wherein the sampling circuit samples an output signal of the selector according to the OR signal.

3. The display device of claim 1,
wherein the display panel is a active-matrix display panel including:
a plurality of first source lines to which an output signal of the first drive circuit is fed;
a plurality of second source lines to which an output signal of the second drive circuit is fed;
a plurality of gate lines that cross the first and second source lines; and
a plurality of active elements of which sources are connected to the first or second source lines, of which gates are connected to the gate lines, and of which drains are connected to pixel segment electrodes.

4. The display device of claim 1,
wherein the first and second pixels are each divided into a plurality of pixel segments, and the selector feeds either a plurality of image signals fed in so as to correspond to the plurality of divided pixel segments or a non-display signal to the sampling circuit.

5. The display device of claim 1,
wherein, of the first and second pixels that the display panel has, at least either the first or second pixels are so arranged as to have varying areas in a left/right direction with the display panel seen from in front.

6. The display device of claim 5,
wherein at least either the first or second pixels are so formed as to have increasingly large areas in the left/right direction.

7. The display device of claim 5,
wherein the first and second pixels are so formed as to be adjacent to each other, and are so formed that a sum of areas of every two mutually adjacent and corresponding first and second pixels is substantially constant.

8. A display device comprising:
an active-matrix display panel including:
a plurality of source lines;
a plurality of gate lines that cross the source lines;
first pixels that output image light to be directed in a first viewing direction; and
second pixels that output image light to be directed in a second viewing direction;
the first and second pixels both having active elements of which sources are connected to the source lines, of which gates are connected to the gate lines, and of which drains are connected to pixel segment electrodes;
a source line drive circuit for feeding an image signal to the source lines;
a gate line drive circuit for feeding a scanning signal to the gate lines; and
an optical separator arranged on a front face of the display panel for separating the image lights outputted from the first and second pixels to direct the image lights in the first and second viewing directions, respectively,
wherein the display panel includes a plurality of first pixel columns each including a plurality of first pixels and a plurality of second pixel columns each including a plurality of second pixels and is so configured that, in a direction of the columns, along each of which first or second pixels are arrayed contiguously, gate lines are provided so that each gate line is connected commonly to all the pixels in one column and that, in a direction of rows, along each of which first and second pixels are arrayed alternately, source lines are provided so that each source line is connected commonly to all the pixels in one row.

9. The display device of claim 8,
wherein the gate line drive circuit includes:
a shift register that generates a first and a second scanning signal by shifting a start pulse in synchronism with a clock signal; and
a logic gate circuit that generates a first and a second AND signal by performing AND operation between the first scanning signal and a first switch signal and between the second scanning signal and a second switch signal, the first and second switch signals both being binary, and
wherein the gate line drive circuit feeds, as the scanning signal, the first AND signal to the first pixel columns and the second AND signal to the second pixel columns.

10. The display device of claim 8,
wherein the gate line drive circuit includes:
a first shift register that generates a first scanning signal by shifting a first start pulse in synchronism with a first clock signal;
a second shift register that generates a second scanning signal by shifting a second start pulse in synchronism with a second clock signal;
a first switch that controls, according to a first switch signal, whether or not to feed the first clock signal to the first shift register or whether or not to feed the first start pulse to the first shift register; and
a second switch that controls, according to a second switch signal, whether or not to feed the second clock signal to the second shift register or whether or not to feed the second start pulse to the second shift register, and
wherein the gate line drive circuit feeds, as the scanning signal, the first scanning signal to the first pixel columns and the second scanning signal to the second pixel columns.

11. The display device of claim 8,
wherein the first and second pixels are each divided into a plurality of pixel segments, and the selector feeds either a plurality of image signals fed in so as to correspond to the plurality of divided pixel segments or a non-display signal to the sampling circuit.

12. The display device of claim 8,
wherein, of the first and second pixels that the display panel has, at least either the first or second pixels are so arranged as to have varying areas in a left/right direction with the display panel seen from in front.

13. The display device of claim 12,
wherein at least either the first or second pixels are so formed as to have increasingly large areas in the left/right direction.

14. The display device of claim 12,
wherein the first and second pixels are so formed as to be adjacent to each other, and are so formed that a sum of areas of every two mutually adjacent and corresponding first and second pixels is substantially constant.

15. A display panel comprising:
a plurality of first pixels for displaying a first image that can be viewed from one of a leftward and a rightward directions with the display panel seen from in front; and
a plurality of second pixels for displaying a second image that can be viewed from the other of the leftward and rightward directions,
wherein, of the first and second pixels, at least either the first or second pixels are so arranged as to have varying areas in a left/right direction.

16. The display panel of claim 15,
wherein, of the first and second pixels, at least either the first or second pixels are so formed as to have increasingly large areas in the left/right direction.

17. The display panel of claim 15,
wherein the first and second pixels are so formed as to be adjacent to each other, and are so formed that a sum of areas of every two mutually corresponding adjacent first and second pixels is substantially constant.

18. The display panel of claim 15,
wherein, of the first and second pixels, at least either the first or second pixels are each divided into a plurality of pixel segments.
